(19) United States
(12) Patent Application Publication
(10) Pub. No.: US 2025/0024556 A1
(43) Pub. Date: Jan. 16, 2025

(54) Device with selective RF communications

(71) Applicant: Malcolm K. Beyer, III, Boca Raton, FL (US)

(72) Inventor: Malcolm K. Beyer, III, Boca Raton, FL (US)

(21) Appl. No.: 18/771,558

(22) Filed: Jul. 12, 2024

Related U.S. Application Data
(60) Provisional application No. 63/526,454, filed on Jul. 12, 2023.

(51) Int. Cl. H04W 76/30; H04W 48/02

(52) U.S. Cl. CPC H04W 76/30; H04W 48/02

(57) ABSTRACT

Systems and methods for providing selective radio frequency communications using a cellular device. In some embodiments, the method includes disabling all radio frequency communications from the cellular device; receiving a command to enable radio frequency communications; enabling radio frequency communications from the cellular device for data or voice communications in response to the received command; and automatically disabling all radio frequency communications from the cellular device when the data or voice communications cease.

### CROSS-REFERENCE TO RELATED APPLICATIONS

The present application claims the benefit of and priority to U.S. Provisional Application No. 63/526,454, filed on Jul. 12, 2023, the entire disclosure of which is hereby incorporated by reference as if set forth in its entirety herein.

### TECHNICAL FIELD

Embodiments described herein generally relate to methods and systems for selective radio frequency (RF) communications and, more particularly but not exclusively, to systems and methods for cellular devices with selective RF communications.

### BACKGROUND

Conventional mobile communication devices such as cell phones often use networks of cell towers to transmit data and voice communications. Cell phones maintain communications as they move between cellular base stations through a process called “handover.” To accomplish this, cell phones are constantly transmitting signals to determine which base stations have the strongest response to their transmitted signals. Furthermore, cell phones are not able to only receive data without transmitting data. Rather, cellular voice and data communications are full duplex so that data can be transmitted and received at the same time.

The use of cellular devices such as cell phones in the field is currently prohibited by most military organizations because these constant transmissions to base stations from cell phones in connection with the handover process make it easy for radio transmission detection devices to detect the transmission and then locate and target the cell phone's location with munitions. Since cell phones are full duplex devices there is no way to avoid detection by receiving data without transmitting any data.

In contrast, radio devices do not use base stations to facilitate communications. Radio devices only transmit data when the radio operator of the device explicitly enables the radio device to transmit. Thus, the radio operator can control the occurrence and length of radio device transmissions to avoid constantly transmitting signals. This lack of constant transmissions limits the ability of hostile forces to determine the location of the radio device. Furthermore, radio devices are also half duplex, which permits the radio device to receive voice and data communications without transmitting signals. Accordingly, when receiving such communications, the radio device is not detectable by radio transmission detection devices. Radio devices, however, are typically more expensive than cell phones and lack the vast and varied computing functionalities of cell phones.

Accordingly, a need exists for improved methods and systems of providing selective RF communications using cellular devices.

### SUMMARY

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

In one aspect, embodiments relate to a method for operating a cellular device. The method includes disabling all radio frequency communications from the cellular device; receiving a command to enable radio frequency communications; enabling radio frequency communications from the cellular device for data or voice communications in response to the received command; and automatically disabling all radio frequency communications from the cellular device when the data or voice communications cease.

In some embodiments, the command is received at a user interface element of a program executing on the cellular device.

In some embodiments, the program is configured to enable and disable radio frequency communications from the cellular device.

In some embodiments, the method further comprises receiving a message from a server indicating that the data or voice communications have ceased, wherein the automatically disabling all radio frequency communications from the cellular device is in response to the message.

In some embodiments, the automatically disabling all radio frequency communications is in response to the data or voice communications ceasing for at least a predetermined interval.

In some embodiments, the data or voice communications are transmitted using Internet Protocol (IP) while radio frequency communications are enabled.

In some embodiments, the method further comprises receiving, by a server, the data or voice communications as communications data when the radio frequency communications are enabled; storing, by the server, the communications data when a receiving device is unavailable; and transmitting, by the server, the communications data to the receiving device when the receiving device is available.

In some embodiments, the method further comprises receiving communications data from a server when the radio frequency communications are enabled, the communications data addressed to the cellular device from a transmitting device.

In some embodiments, the method further comprises receiving a message from the server when the communications data is fully received and the data or voice communications cease, the message indicating that the radio frequency communications should be automatically disabled.

In some embodiments, the method further comprises disabling at least one input mechanism for the cellular device while all radio communications are disabled; enabling the input mechanism in response to the command; and disabling the input mechanism when the data or voice communications cease.

According to another aspect, embodiments relate to a system for operating a cellular device. The system includes a memory storing instructions; and a processor executing the instructions stored on memory to perform the steps of: disabling all radio frequency communications from the cellular device; receiving a command to enable radio frequency communications; enabling radio frequency communications from the cellular device for data or voice communications in response to the received command; and automatically disabling all radio frequency communications from the cellular device when the data or voice communications cease.

In some embodiments, the command is received at a user interface element of a program executing on the cellular device.

In some embodiments, the program is configured to enable and disable radio frequency communications from the cellular device.

In some embodiments, the processor further performs the step of receiving a message from a server indicating that the data or other voice communications have ceased, wherein the processor automatically disabling all radio frequency communications from the cellular device is in response to the message.

In some embodiments, the processor automatically disabling all radio frequency communications is in response to the data or voice communications ceasing for at least a predetermined interval.

In some embodiments, the data or voice communications are transmitted using Internet Protocol (IP) while radio frequency communications are enabled.

In some embodiments, the system further comprises a server configured to perform the steps of: receiving the data or voice communications as communications data when the radio frequency communications are enabled; storing the communications data when a receiving device is unavailable; and transmitting the communications data to the receiving device when the receiving data is available.

In some embodiments, the processor further performs the step of receiving communications data from a server when the radio frequency communications are enabled, the communications data addressed to the cellular device from a transmitting device.

In some embodiments, the processor further performs the step of receiving a message from the server when the communications data is fully received and the data or voice communications cease, the message indicating that the radio frequency communications should be automatically disabled.

In some embodiments, the processor further performs the steps of disabling at least one input mechanism for the cellular device while all radio communications are disabled, enabling the input mechanism in response to the command; and disabling the input mechanism when the data or voice communications cease.

According to yet another aspect, embodiments relate to a computer program product embodied in a non-transitory computer readable storage medium and comprising computer instructions for disabling all radio frequency communications from a cellular device; receiving a command to enable radio frequency communications; enabling radio frequency communications from the cellular device for data or voice communications in response to the received command; and automatically disabling all radio frequency communications from the cellular device when the data or voice communications cease.

In some embodiments, the command is received at a user interface element of a program executing on the cellular device.

In some embodiments, the program is configured to enable and disable radio frequency communications from the cellular device.

In some embodiments, the computer program product further includes computer instructions for receiving a message from a server indicating that the data or voice communications have ceased, wherein the automatically disabling all radio frequency communications from the cellular device is in response to the message.

In some embodiments, the automatically disabling all radio frequency communications is in response to the data or voice communications ceasing for at least a predetermined interval.

In some embodiments, the data or voice communications are transmitted using Internet Protocol (IP) while radio frequency communications are enabled.

In some embodiments, the computer program product further includes computer instructions for receiving, by a server, the data or voice communications as communications data when the radio frequency communications are enabled; storing, by the server, the communications data when a receiving device is unavailable; and transmitting, by the server, the communications data to the receiving device when the receiving device is available.

In some embodiments, the computer program product further comprises instructions for receiving communications data from a server when the radio frequency communications are enabled, the communications data addressed to the cellular device from a transmitting device.

In some embodiments, the computer program product further includes computer instructions for receiving a message from the server when the communications data is fully received and the data or voice communications cease, the message indicating that the radio frequency communications should be automatically disabled.

In some embodiments, the computer program product further includes computer instructions for disabling at least one input mechanism for the cellular device while all radio communications are disabled; enabling the input mechanism in response to the command; and disabling the input mechanism when the data or voice communications cease.

### BRIEF DESCRIPTION OF DRAWINGS

Non-limiting and non-exhaustive embodiments of this disclosure are described with reference to the following figures, wherein like reference numerals refer to like parts throughout the various views unless otherwise specified:

FIG. 1 depicts a flowchart of a method for selective RF communications with a cellular device in accordance with an embodiment;

FIG. 2A depicts a cellular device for selective RF communications in accordance with an embodiment;

FIG. 2B depicts a cellular device for selective RF communications in accordance with another embodiment; and

FIG. 3 depicts a flowchart of a method for selective RF communications with a cellular device in accordance with another embodiment.

### DETAILED DESCRIPTION

Various embodiments are described more fully below with reference to the accompanying drawings, which form a part hereof, and which show specific exemplary embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment. The appearances of the phrase “in some embodiments” in various places in the specification are not necessarily all referring to the same embodiments.

Some portions of the description that follow are presented in terms of symbolic representations of operations on non-transient signals stored within a computer memory. These descriptions and representations are used by those skilled in the data processing arts to most effectively convey the substance of their work to others skilled in the art. Such operations typically require physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices. Portions of the present disclosure include processes and instructions that may be embodied in software, firmware or hardware, and when embodied in software, may be downloaded to reside on and be operated from different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMS, EEPROMs, magnetic or optical cards, application specific integrated circuits (ASICs), or any type of media suitable for storing electronic instructions, and each may be coupled to a computer system bus. Furthermore, the computers referred to in the specification may include a single processor or may be architectures employing multiple processor designs for increased computing capability.

The processes and displays presented herein are not inherently related to any particular computer or other apparatus. Various general-purpose systems may also be used with programs in accordance with the teachings herein, or it may prove convenient to construct more specialized apparatus to perform one or more method steps. The structure for a variety of these systems is discussed in the description below. In addition, any particular programming language that is sufficient for achieving the techniques and implementations of the present disclosure may be used. A variety of programming languages may be used to implement the present disclosure as discussed herein.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

As discussed above, currently available techniques for providing selective RF communications using cellular devices are insufficient and ineffective. The embodiments herein provide techniques for selective RF communications using a cellular device. Moreover, certain embodiments are useful in combination with a server, where the server may transmit and receive communications data in connection with another cellular device. These embodiments may include disabling all radio frequency communications from the cellular device; receiving a command to enable radio frequency communications; enabling radio frequency communications from the cellular device for data or voice communications in response to the received command; and automatically disabling all radio frequency communications from the cellular device when the data or voice communications cease.

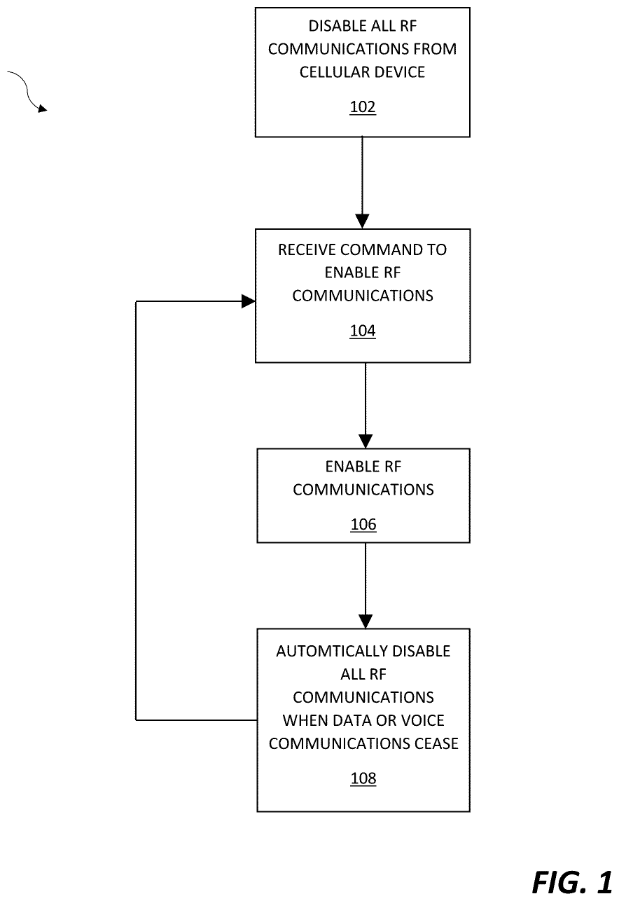

FIG. 1 depicts a flowchart of a method 100 for selective RF communications with a cellular device in accordance with an embodiment. While FIG. 1 shows illustrative steps according to one embodiment, other embodiments may omit, add to, reorder, and/or modify any of the steps shown in FIG. 1. Moreover, each of the steps depicted in FIG. 1 may be performed in any of the ways described herein. Any combination of the steps in FIG. 1 may be performed by a cellular device and/or a program executing on the cellular device, such as an application, a service, and/or an operating system.

Step 102 involves disabling all radio frequency (RF) communications from a cellular device. The cellular device may be configured to communicate using at least one type of RF communications, such as cellular networks (e.g., 5G), Wi-Fi, Bluetooth, Near Field Communication (NFC), and/or Global Positioning System (GPS). At least part of the RF communications may use Internet Protocol (IP). The cellular device may be configured to execute at least one program (e.g., an application, an operating system, etc.). The program may be configured to manage various communications settings and/or protocols for the cellular device.

In some embodiments, all RF communications may be disabled by enabling an “airplane mode” for the cellular device. The airplane mode may be configured as the default mode for the cellular device. That is, all radio frequency communications may be continuously disabled from the cellular device unless the cellular device otherwise overrides the airplane mode. In other embodiments, the airplane mode may be activated in response to an event and/or condition, such as user input at the cellular device, a specified geo-location of the cellular device, and/or a specified environment of the cellular device.

While the RF communications are disabled, voice and data communications may be stored at the cellular device for later transmission when the RF communications are enabled. For example, an operator of the cellular device may record a voice memo for transmission that is stored and only transmitted when RF communications are enabled. The operator may similarly, e.g., draft replies to received emails, with the replies being transmitted later once RF communications are enabled.

Step 104 involves receiving a command to enable RF communications. The command may be received from a user or operator of the cellular device. For example, a user may input a selection at the cellular device (e.g., within the program) for enabling radio frequency communications. In some embodiments, the command may be received from an external device and/or system. For example, a server in communication with the cellular device may send a command for enabling RF communications to the cellular device.

Step 106 involves enabling RF communications from the cellular device for data or voice communications in response to the received command. Enabling RF communications from the cellular device may correspond to the cellular device exiting the airplane mode. The enabled RF communications may be a subset of all the RF communications from the cellular device (e.g., the RF communications disabled in step 102). For example, only Wi-Fi or Bluetooth communications may be enabled. In some examples, only RF communications that use IP (e.g., with a server) may be enabled. In this manner, the cellular device may be forced to communicate using certain types of RF communication and/or protocols.

Alternatively, in some embodiments, RF communications from the cellular device may be automatically enabled in response to a condition related to the cellular device. For example, the condition may be the cellular device receiving communications data addressed from a particular device (e.g., an external cellular device with a particular identification number). In some embodiments, the condition may be a predetermined time interval, a predetermined time stamp, and/or a geo-location of the cellular device.

Step 108 involves automatically disabling all RF communications from the cellular device when the data or voice communications cease. The data or voice communications may be determined to cease when the cellular device no longer transmits or receives communications data. In some embodiments, the cellular device and/or the program may determine that the data or voice communications ceased. In some embodiments, the cellular device may receive a message and/or command (e.g., from an external device and/or system such as a server) indicating that the data or voice communications ceased.

In some embodiments, the data or voice communications must cease for at least a predetermined interval before automatically disabling all RF communications. In some embodiments, the predetermined interval may be at least 10 seconds. The predetermined interval may be selected by the program (e.g., based on conditions related to the cellular device such as location or altitude) and/or a user of the cellular device.

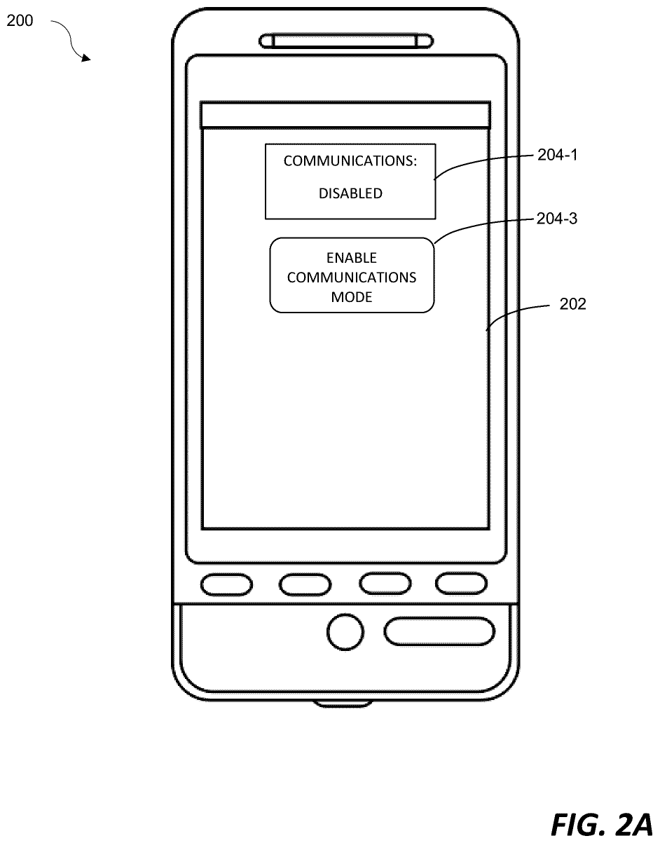

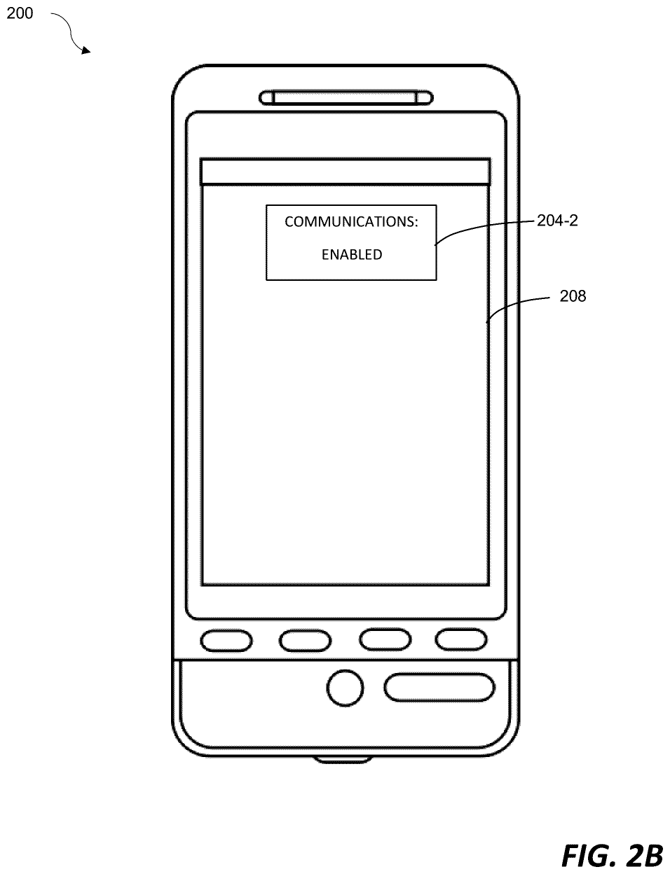

FIG. 2A depicts a cellular device 200 for selective RF communications in accordance with an embodiment. As described above, method 100 may be performed at the cellular device 200 to provide selective RF communications with the cellular device 200.

The cellular device 200 may be any suitable type of mobile device that communicates using cellular networks, such as a flip phone or a smartphone. The cellular device 200 may be configured to execute at least one program, such as an application, operating system, service, microservice, and/or database. The program may be configured to provide selective RF communications with the cellular device 200 (e.g., by performing method 100).

In some embodiments, the program may present at least one graphical element 204 at a user interface 202. For example, the program may present information related to RF communications from the cellular device 200, such as a current mode for RF communications (e.g., disabled, enabled, etc.), a duration of the current mode, and/or a signal strength of the RF communications. As shown with respect to FIG. 2A, the program may present a graphical element 204-1 that informs the user that RF communications are currently disabled (e.g., after step 102 of method 100). As shown with respect to FIG. 2B, a graphical element 204-2 may inform the user that RF communications have been enabled (e.g., after step 106 of method 100).

Returning to FIG. 2A, in some embodiments, the graphical elements 204 may include a graphical element 204-3 for receiving user input at the cellular device 200. A user may interact with the graphical element 204-3 to select an action to be performed by the program. For example, the user may select an option to enable and/or disable RF communications from cellular device 200. The graphical element 204-3 may be presented in any suitable form. As shown, for example, the graphical element 204-3 may be presented as a graphical button.

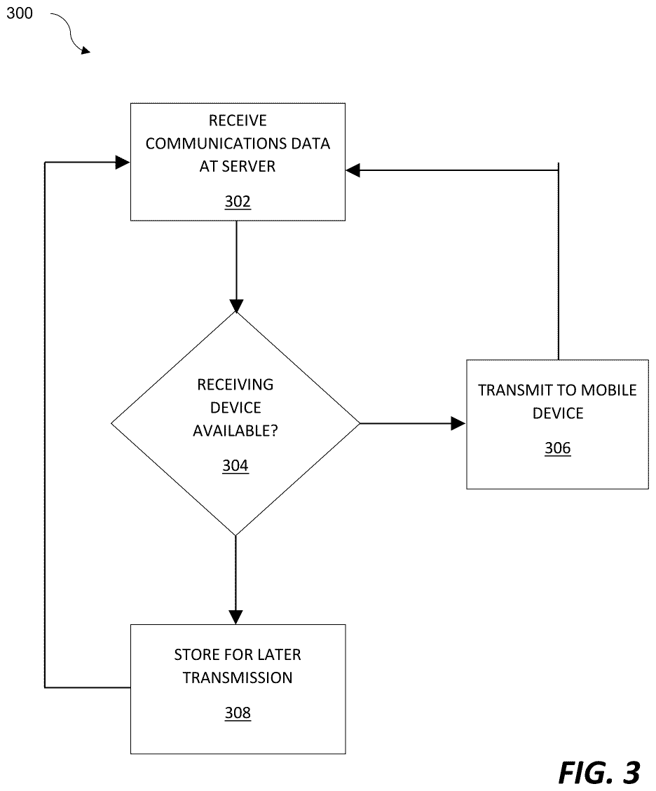

In some embodiments, a cellular device may be configured to communicate with a server for selective RF communications with the cellular device. FIG. 3 depicts a flowchart of a method 300 for selective RF communications with a cellular device in accordance with another embodiment. While FIG. 3 shows illustrative steps according to one embodiment, other embodiments may omit, add to, reorder, and/or modify any of the steps shown in FIG. 3. Moreover, each of the steps depicted in FIG. 3 may be performed in any of the ways described herein. Any combination of the steps in FIG. 3 may be performed by a server in communication with a cellular device and/or any suitable component of the server.

Step 302 involves receiving data or voice communications from a cellular device as communications data when radio frequency communications from the cellular device are enabled. A server in communication with the cellular device may receive the communications data. The server may receive the communications data using any suitable type of RF communications, such as Wi-Fi or Bluetooth. The server may receive the communications data using any suitable type of protocol, such as IP.

Step 304 involves determining whether a receiving device is available. The receiving device may be a communications device such as another cellular device. If the receiving device is available, then step 306 may be performed. Step 306 involves transmitting the communications data to the receiving device. If the receiving device is unavailable, then step 308 may be performed. Step 308 involves storing the communications data for later use. The server may periodically and/or continuously check whether an unavailable receiving device is available until the receiving device becomes available.

In some embodiments, when the server begins receiving communications data from a transmitting device, the server may automatically begin transmitting to the transmitting device any stored communications data received from other devices and addressed to the transmitting device. When the server completes transmitting the stored communications data to the transmitting device, if the server is not actively receiving communications data from the transmitting device, then the server may send a message to cause the transmitting device to disable all RF communications. In some embodiments, all RF communications from the transmitting device may be disabled when the server completes receiving communications data from the transmitting device and/or the transmitting device completes receiving communications data addressed to the transmitting device.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, or alternatively, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of various implementations or techniques of the present disclosure. Also, a number of steps may be undertaken before, during, or after the above elements are considered.

Having been provided with the description and illustration of the present application, one skilled in the art may envision variations, modifications, and alternate embodiments falling within the general inventive concept discussed in this application that do not depart from the scope of the following claims.

What is claimed is:

1. A method for operating a cellular device, the method comprising:
disabling all radio frequency communications from the cellular device;
receiving a command to enable radio frequency communications;
enabling radio frequency communications from the cellular device for data or voice communications in response to the received command; and
automatically disabling all radio frequency communications from the cellular device when the data or voice communications cease.

2. The method of claim 1, wherein the command is received at a user interface element of a program executing on the cellular device.

3. The method of claim 2, wherein the program is configured to enable and disable radio frequency communications from the cellular device.

4. The method of claim 1, further comprising receiving a message from a server indicating that the data or voice communications have ceased,
wherein the automatically disabling all radio frequency communications from the cellular device is in response to the message.

5. The method of claim 1, wherein the automatically disabling all radio frequency communications is in response to the data or voice communications ceasing for at least a predetermined interval.

6. The method of claim 1, wherein the data or voice communications are transmitted using Internet Protocol (IP) while radio frequency communications are enabled.

7. The method of claim 1, further comprising:
receiving, by a server, the data or voice communications as communications data when the radio frequency communications are enabled;
storing, by the server, the communications data when a receiving device is unavailable; and
transmitting, by the server, the communications data to the receiving device when the receiving device is available.

8. The method of claim 1, further comprising receiving communications data from a server when the radio frequency communications are enabled, the communications data addressed to the cellular device from a transmitting device.

9. The method of claim 8, further comprising receiving a message from the server when the communications data is fully received and the data or voice communications cease, the message indicating that the radio frequency communications should be automatically disabled.

10. The method of claim 1, further comprising:
disabling at least one input mechanism for the cellular device while all radio communications are disabled;
enabling the input mechanism in response to the command; and
disabling the input mechanism when the data or voice communications cease.

11. A system for operating a cellular device, the system comprising:
a memory storing instructions; and
a processor executing the instructions stored on memory to perform the steps of:
disabling all radio frequency communications from the cellular device;
receiving a command to enable radio frequency communications;
enabling radio frequency communications from the cellular device for data or voice communications in response to the received command; and
automatically disabling all radio frequency communications from the cellular device when the data or voice communications cease.

12. The system of claim 11, wherein the command is received at a user interface element of a program executing on the cellular device.

13. The system of claim 12, wherein the program is configured to enable and disable radio frequency communications from the cellular device.

14. The system of claim 11, wherein the processor further performs the step of receiving a message from a server indicating that the data or voice communications have ceased, wherein the processor automatically disabling all radio frequency communications from the cellular device is in response to the message.

15. The system of claim 11, wherein the processor automatically disabling all radio frequency communications is in response to the data or voice communications ceasing for at least a predetermined interval.

16. The system of claim 11, wherein the data or voice communications are transmitted using Internet Protocol (IP) while radio frequency communications are enabled.

17. The system of claim 12, further comprising a server configured to perform the steps of:
receiving the data or voice communications as communications data when the radio frequency communications are enabled;
storing the communications data when a receiving device is unavailable; and
transmitting the communications data to the receiving device when the receiving data is available.

18. The system of claim 11, wherein the processor further performs the step of receiving communications data from a server when the radio frequency communications are enabled, the communications data addressed to the cellular device from a transmitting device.

19. The system of claim 18, wherein the processor further performs the step of receiving a message from the server when the communications data is fully received and the data or voice communications cease, the message indicating that the radio frequency communications should be automatically disabled.

20. The system of claim 11, wherein the processor further performs the steps of:
disabling at least one input mechanism for the cellular device while all radio communications are disabled;
enabling the input mechanism in response to the command; and
disabling the input mechanism when the data or voice communications cease.

21. A computer program product embodied in a non-transitory computer readable storage medium and comprising computer instructions for:
disabling all radio frequency communications from a cellular device;
receiving a command to enable radio frequency communications;
enabling radio frequency communications from the cellular device for data or voice communications in response to the received command; and
automatically disabling all radio frequency communications from the cellular device when the data or voice communications cease.

22. The computer program product of claim 21, wherein the command is received at a user interface element of a program executing on the cellular device.

23. The computer program product of claim 22, wherein the program is configured to enable and disable radio frequency communications from the cellular device.

24. The computer program product of claim 21, further comprising computer instructions for receiving a message from a server indicating that the data or voice communications have ceased, wherein the automatically disabling all radio frequency communications from the cellular device is in response to the message.

25. The computer program product of claim 21, wherein the automatically disabling all radio frequency communications is in response to the data or voice communications ceasing for at least a predetermined interval.

26. The computer program product of claim 21, wherein the data or voice communications are transmitted using Internet Protocol (IP) while radio frequency communications are enabled.

27. The computer program product of claim 21, further comprising computer instructions for:
receiving, by a server, the data or voice communications as communications data when the radio frequency communications are enabled;
storing, by the server, the communications data when a receiving device is unavailable; and
transmitting, by the server, the communications data to the receiving device when the receiving device is available.

28. The computer program product of claim 21, further comprising computer instructions for receiving communications data from a server when the radio frequency communications are enabled, the communications data addressed to the cellular device from a transmitting device.

29. The computer program product of claim 28, further comprising computer instructions for receiving a message from the server when the communications data is fully received and the data or voice communications cease, the message indicating that the radio frequency communications should be automatically disabled.

30. The computer program product of claim 21, further comprising computer instructions for:
disabling at least one input mechanism for the cellular device while all radio communications are disabled;
enabling the input mechanism in response to the command; and
disabling the input mechanism when the data or voice communications cease.
